(19) United States
(12) Patent Application Publication
(10) Pub. No.: US 2014/0129477 A1
(43) Pub. Date: May 8, 2014

(54) METHODS AND SYSTEMS FOR RANKING ENTITIES

(71) Applicant: Linkedln Corporation, Mountain View, CA (US)

(72) Inventors: Gloria Lau, Los Altos, CA (US); Jacob Bank, Stanford, CA (US)

(73) Assignee: Linkedln Corporation, Mountain View, CA (US)

(21) Appl. No.: 13/708,770

(22) Filed: Dec. 7, 2012

Related U.S. Application Data
(60) Provisional application No. 61/722,036, filed on Nov. 2, 2012.

(51) Int. Cl. G06Q 30/02; G06Q 50/00

(52) U.S. Cl. CPC G06Q 30/0282; G06Q 50/01
USPC 705/347

(57) ABSTRACT

Ranking institutions by creating sub-rankings of desirable outcomes, identifying all members of a social network service who have listed a predetermined indicator in their profile, grouping the members by institution, for each sub-ranking, ordering institutions by the proportion of members achieving the outcome of the sub-ranking, and displaying of the ordered institutions by sub-ranking in an interactive display that enables users to select sub-rankings and view institution ranking within sub-rankings In one embodiment the institutions may be undergraduate schools and the predetermined indicator may be a bachelor degree.

### TECHNICAL FIELD

The present disclosure generally relates to data processing systems and techniques for processing and presenting content within an online social network environment. More specifically, the present disclosure relates to methods and systems for analyzing and aggregating information, such as specific outcomes achieved from people associated with an organization. As one example, education and post-graduate position information of individual members of a social network service is aggregated so as to present the aggregated information in an interactive manner that enables members of the social network service to explore a wide variety of university outcome information may be used to rank universities.

### BACKGROUND

A social network service is a computer- or web-based application that enables its members or users to establish links or connections with persons for the purpose of sharing information with one another. In general, a social network service enables people to memorialize or acknowledge the relationships that exist in their “offline” (i.e., real-world) lives by establishing a computer-based representation of these same relationships in the “online” world. Many social network services require or request that each user, sometimes called members, provide personal information about the user, such as professional information including information regarding their educational background, employment positions that the user has held, and so forth. This information is frequently referred to as “profile” information, or “member profile” information. In many instances, social network services enable users, with the appropriate data access rights, to view the personal information (e.g., member profiles) of other users. Although such personal information about individual users can be useful in certain scenarios, it may not provide many insights into “big picture” questions about various professions, careers, and individual jobs or employment positions.

### DESCRIPTION OF THE DRAWINGS

Some embodiments are illustrated by way of example and not limitation in the Figures of the accompanying drawings, in which:

FIG. 1 is a functional block diagram illustrating various functional modules or components of a social/business network service, with which an embodiment described herein might be implemented;

FIG. 2 flowchart illustrating the operation of a method according to an embodiment;

FIG. 3 is an illustration of user interface useful for ranking by a plurality of sub-rankings according to an embodiment;

FIG. 4 is an illustration of a user interface useful for ranking by one sub-ranking according to an embodiment;

FIGS. 5-14 are illustrations of results of ranking universities by individual sub-rankings;

FIG. 15A is an illustration of a composite, or overall, ranking according to an embodiment;

FIG. 15B is an illustration of another composite, or overall, ranking according to an embodiment;

FIG. 16 is a block diagram of a machine in the form of a computing device within which a set of instructions, for causing the machine to perform any one or more of the methodologies discussed herein, may be executed.

### DETAILED DESCRIPTION

Methods and systems for ranking entities are described. Ranking schools is used as an example. In the following description, for purposes of explanation, numerous specific details are set forth in order to provide a thorough understanding of the various aspects of different embodiments of the present invention. It will be evident, however, to one skilled in the art, that the present invention may be practiced without these specific details.

College rankings have become a major force in U.S. higher education, influencing the matriculation decisions of prospective undergraduates. As the significance of university rankings increases, so too does the scrutiny to which the methodologies are subjected. The best-known rankings, produced by U.S. News and World Report, are derived from a weighted aggregation of peer surveys of institution quality, along with data on retention rates, student selectivity, faculty and financial resources, graduation rate performance, and alumni giving.

A new framework may be used to rank universities, by evaluating how well they produce a wide variety of desirable post-graduate outcomes, including degrees from graduate and professional schools, and positions in specific industries and roles. Using data from a professional social network service on tens of millions of professionals, the ranking system creates ten individual sub-rankings of universities, comparing schools by how likely their students are to achieve specific outcomes. More or fewer than ten may be used. The composite overall ranking may be created by an average of the sub-rankings, weighted approximately according to actual prevalence of the outcome in labor data from the U.S. Department of Labor, Bureau of Labor Statistics [2010]. This system uses a huge data set to create concrete, data-driven, outcome rankings that provide unique insights for students that have specific goals, and a generally useful composite ranking for those that do not.

The embodiments have wider application than ranking undergraduate institutions, and may be used for ranking any institutions, regardless of type, such as, without limitation, clubs, teams, social organizations, and other such institutions. When applied to ranking undergraduate institutions, the embodiments are described in the context of members who indicate a bachelor degree on their member profile. However, when ranking other types of institutions, one of ordinary skill in the art will understand that the embodiments may be described in the context of members providing any predetermined indicator on their member profile. Similarly, when ranking undergraduate institutions the sub-rankings of desired outcomes are described in terms of acceptance to graduate schools or jobs obtained in given industries. However, those of ordinary skill in the art will recognize that the desired outcomes will vary by the type of institutions being ranked, with the desired outcomes generally being those outcomes desired by members of the type of institution being ranked. For example, although an embodiment herein describes ranking post-secondary schools, one of ordinary skill in the art will readily recognize that additional embodiments could describe ranking high schools, elementary schools, and even professional certification or accreditation institutions (e.g., LSAT prep, CFA, and the like). In the latter embodiments, one of ordinary skill in the art would recognize the use of schools other than law schools, medical schools, business schools, and other post-graduate schools for the sub-rankings

The method may begin by creating sub-rankings for each desirable outcome, ordering schools by the proportion of undergraduates that go on to achieve the specified result. To do this, the algorithm first identities all of the members of a social network service who have listed a bachelor's degree in their profile, and groups them by undergraduate institution, counting the number of graduates from each school. Schools with under fewer than a threshold number of bachelor's degree holders may be filtered out due to sparsity concerns. In one embodiment, schools with fewer than two-thousand (2,000) bachelor degree holders in the social network service are filtered out, leaving a set of approximately eight hundred (800) schools. Next, for each sub-ranking, schools are ordered by the proportion of students achieving the outcome of the sub-ranking, calculated by dividing the number of degree holders achieving the result by the total number of degree holders from that school. These numbers, and the numbers associated with the sub-rankings in terms of “top” entities, as described in detail below, depend, to some degree, on the size of the social network service database.

Finally, to produce the composite ranking, the individual outcome rankings are aggregated by taking a weighted average of a school's score in each sub-ranking To make the rankings as generally useful as possible, the sub-rankings may be weighted by the prevalence of each outcome, taken from the Career Guide to Industries produced by the U.S. Department of Labor, Bureau of Labor Statistics. The method replaces subjective surveys with objective outcome data from the social network service's database to create concrete and valuable sub-rankings, and it replaces arbitrary aggregation of sub-rankings with intelligently chosen weights based on population data, to create additional value for the prospective student.

The above method is particularly useful since many social network services, and particularly those with a professional or business focus, request, or even require, users to provide various items of personal information, including information concerning a user's educational background, employment history and career. For example, a user may be prompted to provide information concerning the schools and universities attended, the dates or years of attendance, the subject matter concentration (e.g., academic concentration or major), as well as the professional certifications and/or academic degrees that the user has obtained. Similarly, a user may be prompted to provide information concerning the companies for which he or she has worked, the employment positions (e.g., job titles) held, the dates of such employment, the skills obtained, and any special recognition or awards received. The data that is requested and obtained may be structured, or unstructured. Other information may be requested and provided as well, such as a professional summary, which summarizes a user's employment skills and experiences, or an objective or mission statement, indicating the user's professional or career aspirations. For purposes of this disclosure, the above-described data or information is generally referred to as member profile data or member profile information. Furthermore, each individual item of data or information may be referred to as a member profile attribute.

Consistent with some embodiments, a social network service includes a school ranking information aggregation service, which is referred to hereinafter as the “school ranking module” or “school ranking application.” Consistent with some embodiments, the school ranking application analyzes and aggregates the member profile information of all (or some subset of) members of the social network service to provide a rich and easy to access set of tools that enables users to explore and discover a variety of ranking information, and possibly trends, concerning various schools as they relate to industries, professions, employments positions, and/or careers.

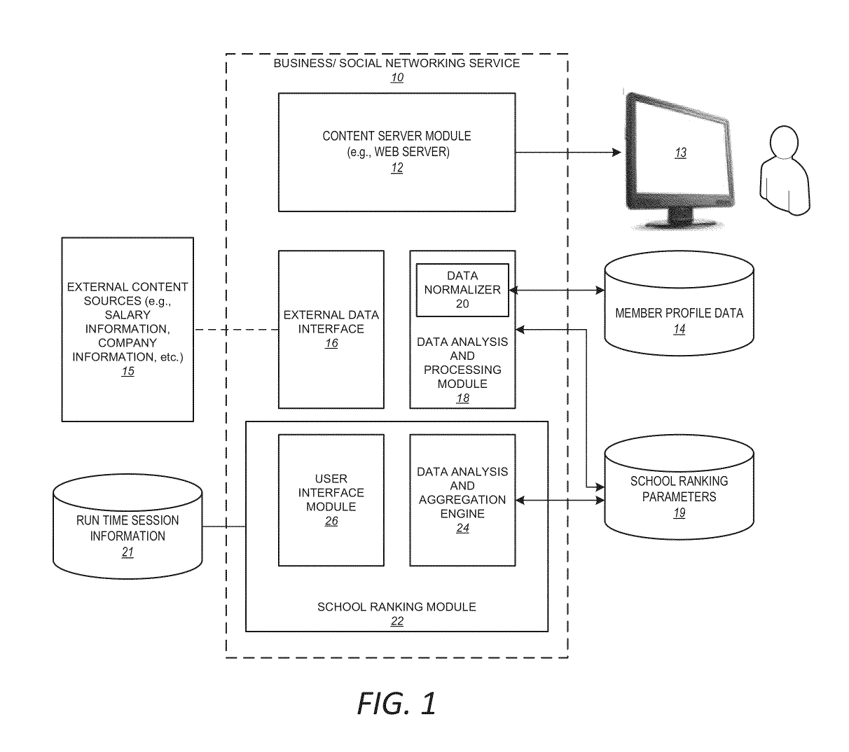

FIG. 1 is a functional block diagram illustrating various functional modules or components of a social/business network service 10, with which an embodiment might be implemented. The various functional modules illustrated in FIG. 1 may be embodied in hardware, software, or a combination thereof. Furthermore, although shown in FIG. 1 as a single set of modules, a skilled artisan will appreciate that with some embodiments, the individual components may be distributed amongst many server computers, forming a distributed, cluster-based architecture. In addition, as presented in FIG. 1, the school ranking application is represented as a module 22 integral with the social network service 10. In other embodiments, the school ranking application may be a separate web-based application that simply uses one or more sets of application programming interfaces (APIs) to leverage one or more separately hosted social network services.

As illustrated in FIG. 1, the social network service 10 includes a content server module (e.g., a web server module) 12 configured to send and receive information (e.g., web pages, or web-based content) with various web-based communication protocols to various client applications and devices, including web browser applications and/or other content rendering applications. With some embodiments, users interact with the service 10 via a web browser application, or some other content rendering application, that resides and executes on a client computing device, such as that with reference number 13 in FIG. 1. Client computing devices may include personal computers, as well as any of a wide number and type of mobile devices, such as laptop computers, tablet computers, mobile phones, and so forth. By interacting with the client computing device, a user can request and receive web pages from the service 10. With some embodiments, the web pages will prompt the user to provide various member profile attribute information (e.g., schools and/or universities attended, academic degrees received, academic majors, employment history information, and so forth), which, is then communicated to the service 10 and stored in a storage device as member profile data 14.

The service 10 includes an external data interface 16 to receive data from one or more externally hosted sources. For instance, with some embodiments, certain information about companies and/or particular job titles or employment positions (e.g., salary ranges) may be obtained from one or more external sources. With some embodiments, such data may be accessed in real-time, while in other embodiments the data may be imported periodically and stored locally at the social network service that is hosting the school ranking application.

With some embodiments, the volume of member profile data that is available for processing is extremely large. Accordingly, as shown in FIG. 1, with some embodiments, the social network service 10 includes a data analysis and processing module 18. With some embodiments, this processing module may be implemented with a distributed computing system, such as Apache™ Hadoop™ The processing module 18 obtains as input various attributes of member profile information, and then processes this information to ensure that is in a usable form for the school ranking application. For instance, the data normalizer module 20 will normalize various elements of data, ensuring that they conform to some standard that is used by the school ranking application. With some embodiments, the various job titles that users specify for themselves are normalized by deduplicating and disambiguating the job titles. For instance, in many cases, the same employment position will have a different job title at different companies. Accordingly, with some embodiments, the data normalizer module 20 will deduplicate job titles by mapping the different job titles, as specified in users' member profiles, to uniquely named job titles for use with the school ranking application. In addition to deduplicating job titles, with some embodiments the data normalizer will disambiguate job titles. For instance, in many cases, a particular job title may be used in two different industries, such that the two employment positions represented by the same job title are really very different. A few examples include the job titles, “associate” and “analyst.” A financial analyst may be a completely different position from a security analyst, and so forth. Accordingly, with some embodiments, the data normalizer 20 will analyze various elements of a user's member profile to determine the industry in which the user works, such that the job title for the user can be specified uniquely for that industry. The originally input data, before standardization, may be stored in case it is needed in the future to check standardization. In that instance it is a copy of the originally input data that may be used for standardization by data normalizer module 20.

In addition to normalizing various items of information, with some embodiments, the processing module 18 obtains or otherwise derives a set of school ranking parameters from or based on profile attributes of the members for use in ranking as discussed below. At least with some embodiments, these parameters are updated periodically (e.g., daily, nightly, bi-daily, weekly, every few hours, etc.) to take into account changes members make to their profiles.

School ranking parameters are stored for use with the school ranking application 22, as shown in FIG. 1 in a database with reference number 19. With some embodiments, the school ranking parameters are stored in a distributed key-value storage system, such as the open sourced storage system known as the Voldemort Project. Also illustrated in FIG. 1 is a data analysis and aggregation engine with reference number 24 which is used to process the school ranking parameters to obtain ranking results as discussed below. At run-time, the school ranking parameters are quickly retrieved, and then used with one or more sets or one or more vectors to determine ranking of schools, which may be provided to a user interface in absolute or weighted format. With some embodiments, the profile attributes specified by the member for use with the school ranking application may be separately stored with run-time session information, as illustrated in FIG. 1 with reference number 21.

As illustrated in FIG. 1, the school ranking module 22 includes a data analysis and aggregation engine 24, and a user interface (UI) module 26. The data analysis and aggregation engine analyzes and aggregates the school ranking parameters as discussed in greater detail below. The user interface module 26 includes logic for presenting the information in various formats, for example, as shown in the example user interfaces presented in the attached figures.

Certain attribute information from the member profiles of members of a social network service are retrieved and analyzed for the purpose of normalizing the information for use with the school ranking application. For instance, with some embodiments, job titles may be specified (as opposed to selected) by the members of the social network service and therefore will not be standardized across companies and industries. As such, with some embodiments, a normalizer module will analyze the profile information from which certain job titles are extracted to ascertain an industry specific job title. Accordingly, with some embodiments, the school ranking application will utilize a set of unique, industry specific job titles. Of course, other attributes may also be normalized when appropriate.

### Outcomes in Graduate School

In one embodiment, the first four sub-rankings in the disclosed method judge schools by the proportion of students they produce that attend (1) top business schools, (2) top law schools, (3) top medical schools, and (4) Ph.D. programs. The Ph.D. outcome ranking counts students that achieved Ph.D. degrees at any school, whereas the professional school rankings-law, medicine, and business-only include students that received the professional degree at “top” schools. Top schools may be defined by existing professional school rankings from the US News & World Report [2011]. For law and business schools, schools in the top 25 were in one embodiment treated as “top”, and, for medical schools, schools in the top 50 were treated as “top” due to smaller enrollments. Though these professional schools rankings suffer many of the same shortcomings as the undergraduate rankings, the outcome-based ranking system tempers the small distinctions between positions by treating all schools in the “top” bucket as equal, using the existing rankings as a reasonable snapshot of strong professional schools, not a conclusive ordering.

### Outcomes in Industry

The remaining six outcomes, which could be in the embodiment under discussion, or in a separate embodiment, come from positions in industry: (5) working for top banking companies, (6) working for top consulting companies, (7) holding a position of executive leadership, (8) working in the higher education industry, (9) working for a top tech company, or (10) working with a job function of writing or journalism. For the banking, consulting and technology industries, only employees of the 25 top companies in that industry may be counted because the desirability of jobs in these industries varies significantly based on the quality of the company. Top companies are calculated by aggregating indicators of a company's quality from the social network service's data, including company followers, company page views, average profile views of employees, and more. As an example of “top” companies, the top 5 companies in consulting, according to this metric, using the database of the largest social networking service, are: Accenture, Deloitte, Mckinsey and Company, The Boston Consulting Group, and Slalom Consulting.

For executive leadership and writing or journalism, employees at any company, in those particular job functions, are counted as achieving that outcome. Similarly, for higher education, anyone in that industry is counted, regardless of institution. These outcomes were not constrained to only “top” companies because these positions are often recognized as desirable across a much larger set of companies and institutions.

A position of executive leadership may include, without limitation, chairman of a corporation, chief executive officer of a corporation, president of a corporation, chief technical officer of a corporation, chief marketing officer of a corporation, vice president of a corporation, general counsel of a corporation, and similar positions. General counsel of a corporation and various partnership levels of a law firm may be included within a given standardized grouping.

In another embodiment, the “top” entities need not be used. That is, instead, of “top” business schools, “top” law schools, “top” medical schools, the method may rank schools by the number of graduates they produce that go on to any business school, any law school, or any medical school. Further, community colleges may be ranked on the number of students transferring to four-year colleges. In another embodiment, the rankings need not be limited to working for top consulting companies, holding a position of executive leadership, or working for a top tech company. Instead, the rankings could be based on the number of graduates working in any consulting company, or any technology company. Further, the rankings can be based on other industries, such as, for example, finance and real estate.

In yet another embodiment, the rankings could be based on the number of graduates that start their own business and, as one choice, employ a number of employees, say ten or more.

### Flowcharts

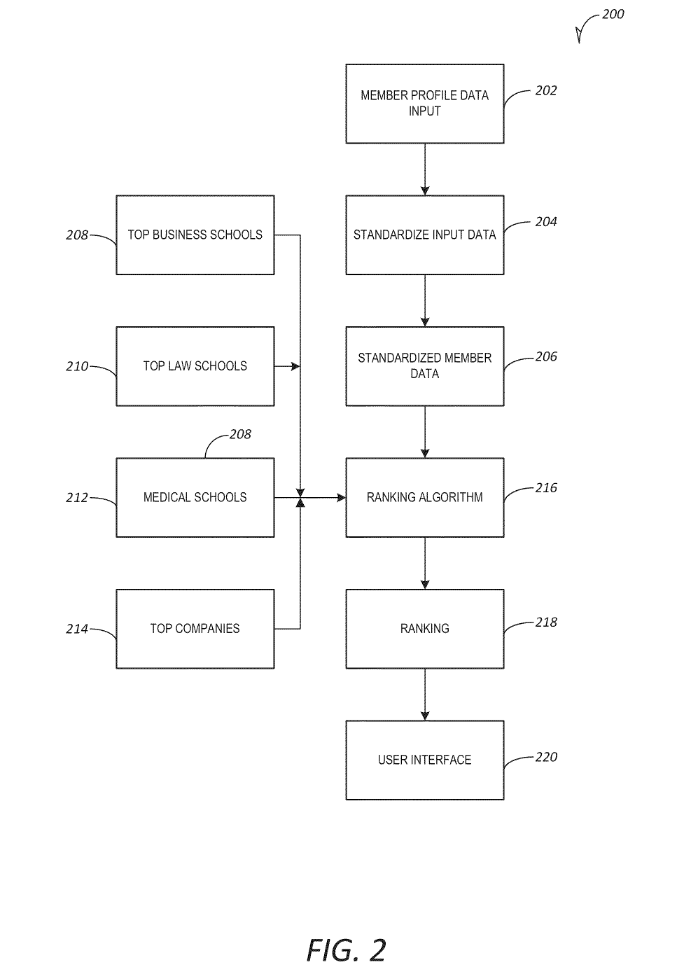

FIG. 2 illustrates operation of method 200 according to an embodiment. Members input profile data at 202, as at 13 of FIG. 1. The input profile data could comprise personal member data that may or may not be in standardized form as explained above with respect to data normalizer 20 of FIG. 1. As examples of input profile data, the data could be personal member data such as age, experience, and the like. The input profile data could also be data members input about their school in standardized or non-standardized form. The input data at 202 could also be data designating a particular industry in standard or non-standard data. As needed, this data is standardized at 204, again, as explained with respect to data normalizer 20 of FIG. 1, resulting in standardized member data at 206, which is transmitted to ranking algorithm 216. The ranking algorithm 216 may be the algorithm discussed above, of ranking schools by the number of graduates in various sub-rankings The ranking 218 is accomplished as discussed above. For each sub-ranking, schools are ordered by the proportion of students achieving the outcome of the sub-ranking, calculated by dividing the number of degree holders achieving the result by the total number of degree holders from that school. Finally, the results may be rendered at a user interface as at 220.

Continuing with FIG. 2, data about organizations as to which ranking is to be carried out is transmitted to ranking algorithm 216. For example, when ranking schools as to graduates accepted to top business schools, then top business school data, that is, which are the top N business schools for comparison purposes would be presented at 208 to the ranking algorithm 216. When ranking schools as to graduates accepted to top law schools, then top law school data would be presented at 210. When ranking schools as to graduates accepted to top medical schools, top medical schools would be presented at 212. When ranking schools as to graduates obtaining jobs at top companies, then data with respect to top companies is presented at 212. As a further example, if the ranking algorithm were to rank schools with respect to schools that were from which graduates were most likely to start their own company, data with respect to top companies would not be needed from 208. Further, if the ranking algorithm were to rank schools from which graduates were most likely to be accepted to a Ph. D. program, then, again, data with respect to top companies would not be needed from 208. In alternative embodiments, additional sub-rankings could be made, such as graduates achieving jobs in any finance industry, in any technology company, in any real estate company, in any law school, in any medical school. Community colleges could have a sub-ranking for graduates accepted to four-year colleges.

### Results

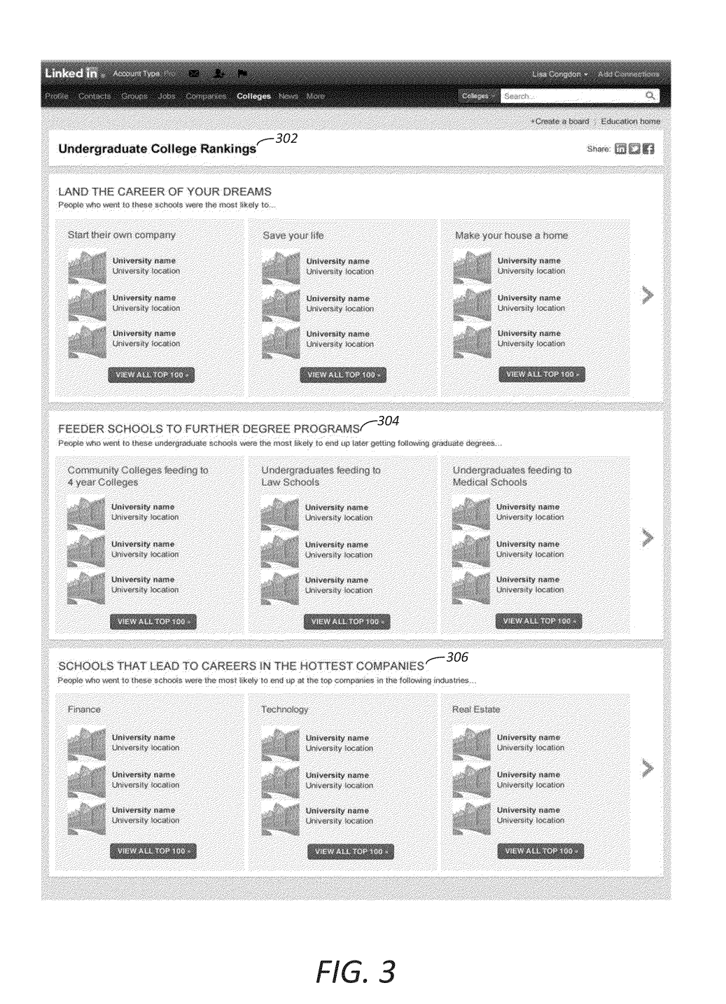

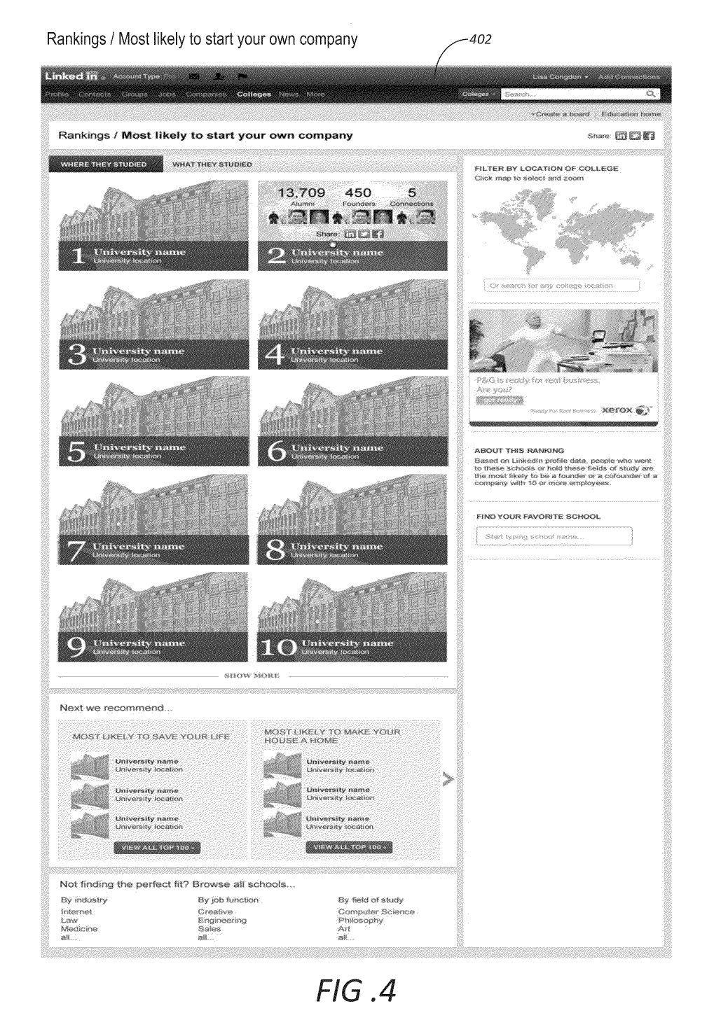

Examples of user interfaces are seen at FIGS. 3, and 4. FIG. 3 illustrates how a user interface might look to illustrate ranking schools by several sub-rankings on one user interface. Examples include ranking schools by desirable careers outcome 302, schools leading to further degree programs, 304, and schools leading to careers outcomes in top companies 306. For situations in which there are more than one hundred schools ranked, a selectable “View All Top 100” icon may be included to show the top one-hundred schools in that sub-ranking One of ordinary skill in the art will recognize the number need not be one-hundred, and that any reasonable number may be in the ranking FIG. 4 illustrates how a user interface might look to illustrate ranking schools according to one sub-ranking Here the top 10 schools are illustrated by ranking FIG. 4 merely illustrates one example how the rankings might be illustrated, so there are no names of schools placed on the figure. FIG. 4 in this example illustrates the top ten schools whose alumni are most likely to found their own companies. The schools in each of the top ten graphics, 1-10, may be illustrated with name and a recognizable campus structure. As seen at 402, mousing over a school may show additional information. For example, for the university that would be named at 402, there are 13,709 alumni registered with the social network service, of which 450 are founders of a company. Of these 450, five might be connected to the user who is viewing FIG. 4 on the user's GUI. A selectable icon leading to schools beyond the top 10 may be included, as was done in FIG. 3. One of ordinary skill in the art will recognize that FIGS. 3, 4 are illustrative only, and that many additional ways of illustrating rankings are within the ordinary skill in the art. The user interfaces may display the schools as ordered institutions by sub-ranking in an interactive display that enables users to select sub-rankings and view undergraduate institution ranking within sub-rankings

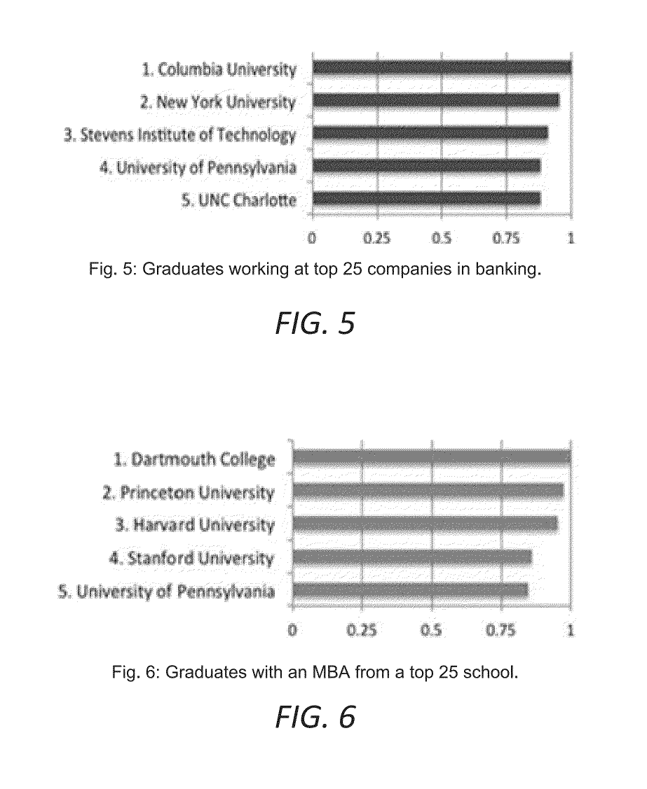

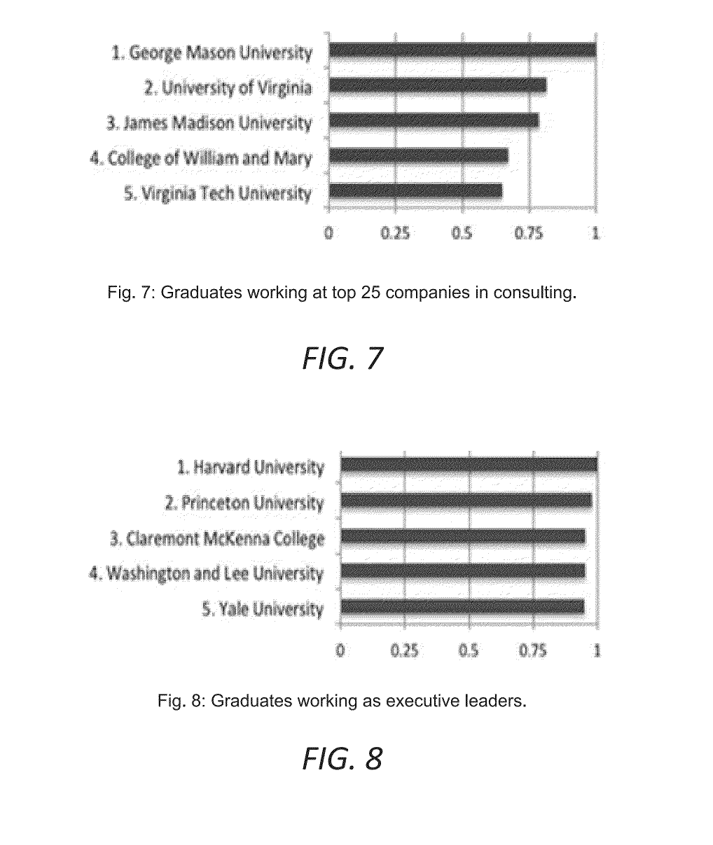

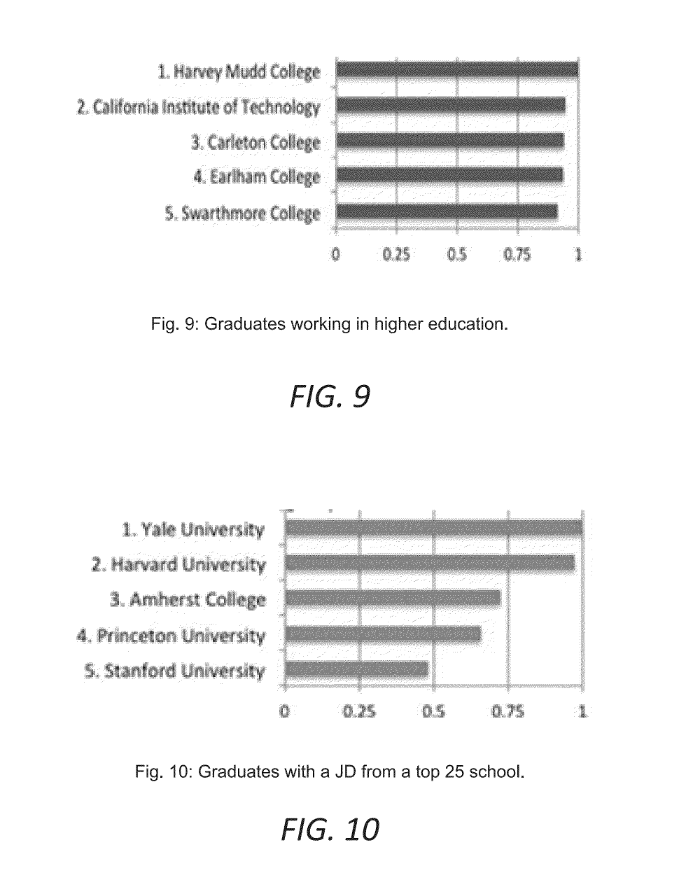

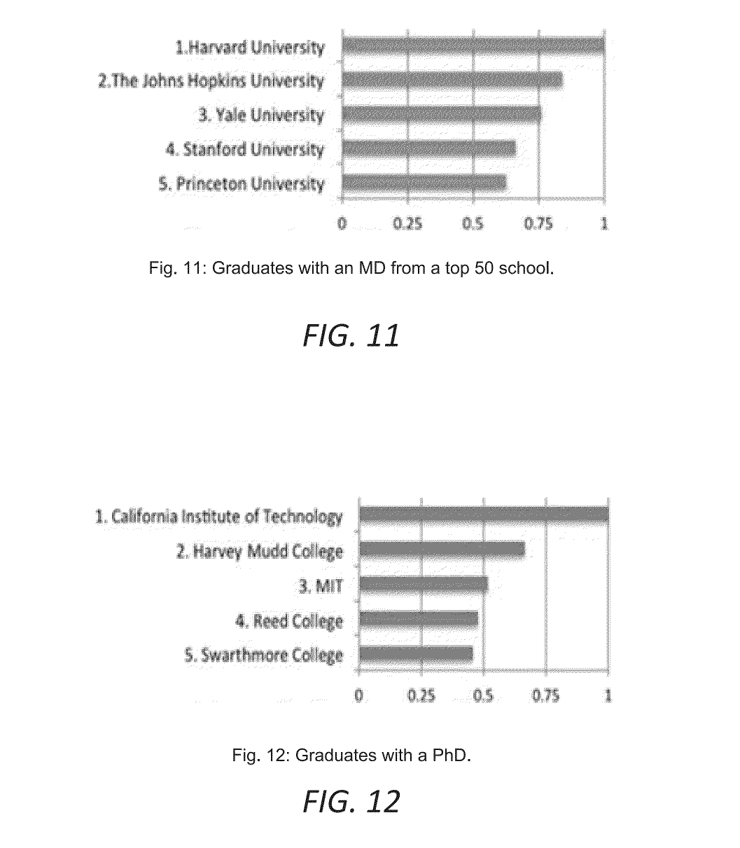

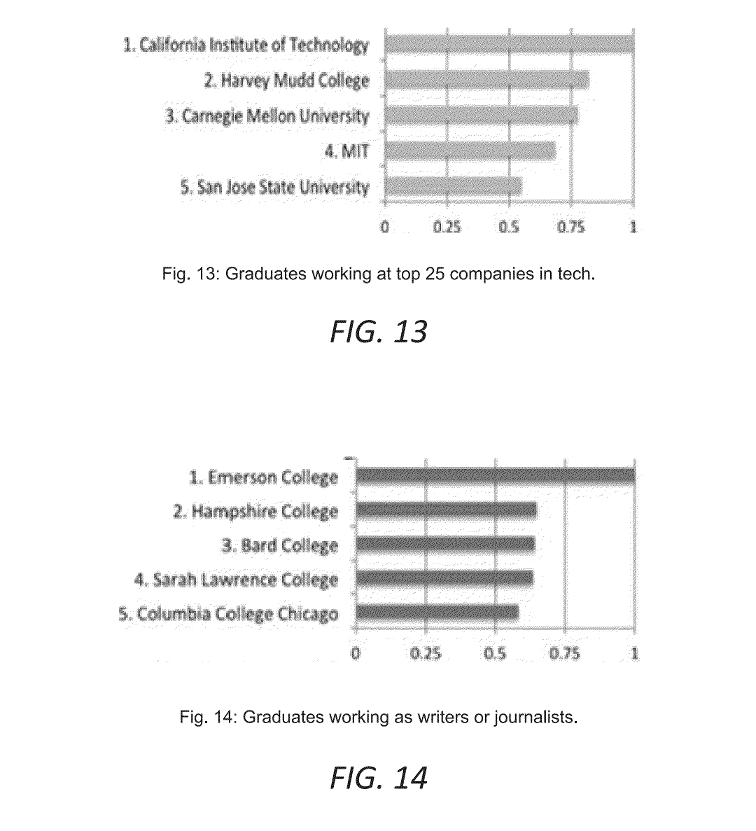

Using the databases of a professional social network service as of 2011, and using data standardization in use at that period of time, FIGS. 5-14 show the top five schools in each sub-ranking named in the respective figure, with relative bars indicating the proportion of students achieving the given outcome, scaled such that the top school has a score of one.

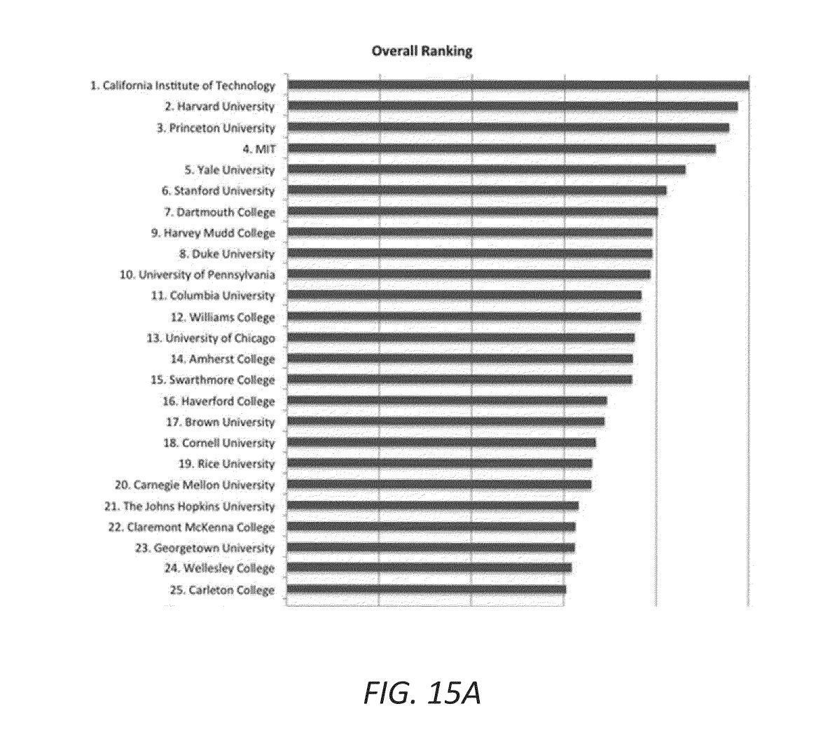

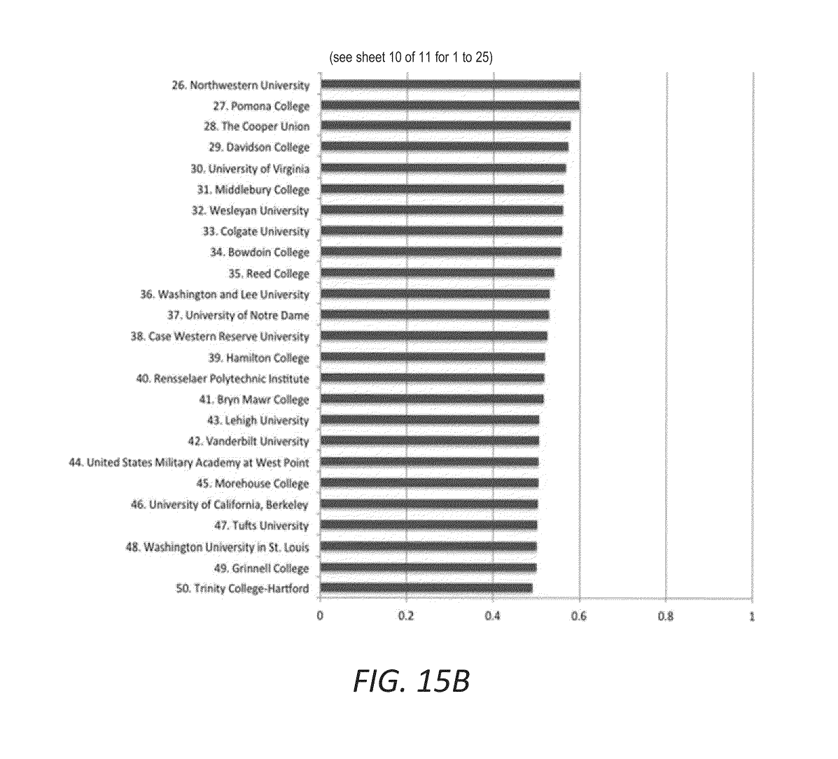

As discussed above, a composite overall ranking may be created by an average of the sub-rankings, weighted approximately according to actual prevalence of the outcome in labor data from the U.S. Department of Labor, Bureau of Labor Statistics [2010]. This system uses a huge data set to create concrete, data-driven, outcome rankings that provide unique insights for students that have specific goals, and a generally useful composite ranking for those that do not. FIG. 15A shows schools 1-25 in the overall composite ranking, again using the professional social network service databases as discussed in the paragraph next above. FIG. 15B shows schools 25-50 in the overall composite ranking

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

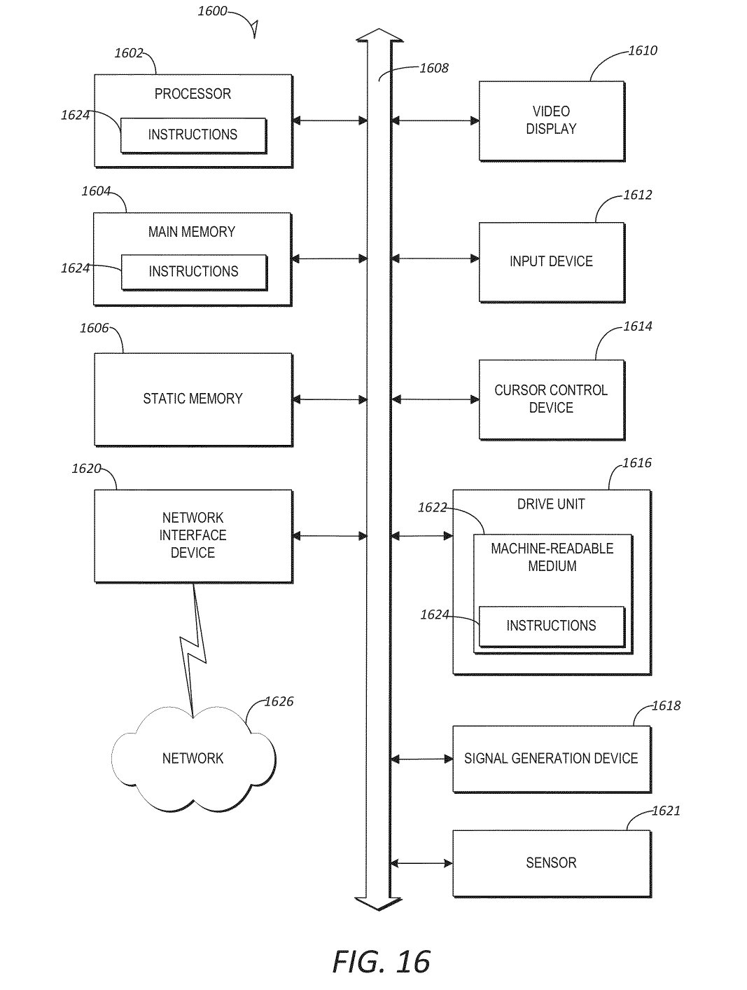

FIG. 16 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1601 and a static memory 1606, which communicate with each other via a bus 1608. The computer system 1600 may further include a display unit 1610, an alphanumeric input device 1617 (e.g., a keyboard), and a user interface (UI) navigation device 1611 (e.g., a mouse). In one embodiment, the display, input device and cursor control device are a touch screen display. The computer system 1600 may additionally include a storage device 1616 (e.g., drive unit), a signal generation device 1618 (e.g., a speaker), a network interface device 1620, and one or more sensors 1621, such as a global positioning system sensor, compass, accelerometer, or other sensor.

The drive unit 1616 includes a machine-readable medium 1622 on which is stored one or more sets of instructions and data structures (e.g., software 1623) embodying or utilized by any one or more of the methodologies or functions described herein. The software 1623 may also reside, completely or at least partially, within the main memory 1601 and/or within the processor 1602 during execution thereof by the computer system 1600, the main memory 1601 and the processor 1602 also constituting machine-readable media.

While the machine-readable medium 1622 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1623 may further be transmitted or received over a communications network 1626 using a transmission medium via the network interface device 1620 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
using at least one data processor, creating a plurality of sub-rankings of desirable outcomes;
identifying members of a social network service who have listed a bachelor's degree in their social network service member profile;
grouping the members by undergraduate institution with which they are associated in their member profile;
for at least some of the plurality of sub-rankings, ordering undergraduate institutions by the proportion of graduates who respectively achieve the outcome of the at least some of the plurality of sub-rankings; and
providing signals to render a display of the ordered undergraduate institutions by sub-ranking, the display being an interactive display that enables users to select sub-rankings and view undergraduate institution ranking within sub-rankings

2. The method of claim 1, the ordering comprising creating undergraduate institution ranking scores by counting the number of the members of each group that have respectively achieved the outcome of the at least some of the plurality of sub-rankings, counting the number of the members of each group, and dividing the number of members of each group that have respectively achieved the outcome of the at least some of the plurality of sub-rankings by the number of members of each group.

3. The method of claim 2, further including producing a composite ranking of the undergraduate institutions.

4. The method of claim 3, producing the composite ranking comprising taking a weighted average of each undergraduate institution's ranking score in each of the at least some of the plurality of sub-rankings, and ranking the undergraduate institution according to the sum of the weighted averages for the undergraduate institution.

5. The method of claim 4 wherein each sub-ranking is weighted by the prevalence of the desirable outcome of the sub-ranking from the Career Guide to Industries produced by the U.S. Department of Labor, Bureau of Labor Statistics.

6. The method of claim 2 wherein the desirable outcomes include at least one outcome from the group of outcomes consisting of acceptance to business school, acceptance to law school, acceptance to medical school, acceptance to a Ph.D. program, working for a banking company, working for a consulting company, holding a position of executive leadership, working in the higher education industry, working for a technology company, working with a job function of writing or journalism, and starting a business.

7. The method of claim 6 wherein the at least one of the desirable outcomes is acceptance to a top business school, acceptance to top law school, acceptance to top medical school, working for a top banking company, working for a top consulting company, or working for a top technology company.

8. A machine-readable storage device having therein a set of instructions which, when executed by the machine, causes the machine to execute the following operations:
creating a plurality of sub-rankings of desirable outcomes;
identifying members of a social network service who have listed a bachelor's degree in their social network service member profiles;
grouping the members by undergraduate institution with which they are associated in their member profile;
for at least some of the plurality of sub-rankings, ordering undergraduate institutions by the proportion of graduates who respectively achieve the outcome of the at least some of the plurality of sub-rankings; and
providing signals to render a display of the ordered undergraduate institutions by sub-ranking, the display being an interactive display that enables users to select sub-rankings and view undergraduate institution ranking within sub-rankings.

9. The machine-readable storage device of claim 8, the ordering comprising creating undergraduate institution ranking scores by counting the number of the members of each group that have respectively achieved the outcome of the at least some of the plurality of sub-rankings, counting the number of the members of each group, and dividing the number of members of each group that have respectively achieved the outcome of the at least some of the plurality of sub-rankings by the number of members of each group.

10. The machine-readable storage device of claim 9, further including producing a composite ranking of the undergraduate institutions.

11. The machine-readable storage device of claim 10, producing the composite ranking comprising taking a weighted average of each undergraduate institution's ranking score in each of the at least some of the plurality of sub-rankings, and ranking the undergraduate institution according to the sum of the weighted averages for the undergraduate institution.

12. The machine-readable storage device of claim 11 wherein each sub-ranking is weighted by the prevalence of the desirable outcome of the sub-ranking from the Career Guide to Industries produced by the U.S. Department of Labor, Bureau of Labor Statistics.

13. The machine-readable storage device of claim 9 wherein the desirable outcomes include at least one outcome from the group of outcomes consisting of acceptance to business school, acceptance to law school, acceptance to medical school, acceptance to a Ph.D. program, working for a banking company, working for a consulting company, holding a position of executive leadership, working in the higher education industry, working for a technology company, working with a job function of writing or journalism, and starting a business.

14. The machine-readable storage device of claim 13 wherein the at least one of the desirable outcomes is acceptance to a top business school, acceptance to top law school, acceptance to top medical school, working for a top banking company, working for a top consulting company, or working for a top technology company.

15. A system comprising at least one data processor configured to:
create a plurality of sub-rankings of desirable outcomes;
identify members of a social network service who have listed a bachelor's degree in their social network service member profiles;
group the members by undergraduate institution with which they are associated in their member profile;
for at least some of the plurality of sub-rankings, order undergraduate institutions by the proportion of graduates who respectively achieve the outcome of the at least some of the plurality of sub-rankings; and
provide signals to render a display of the ordered undergraduate institutions by sub-ranking, the display being an interactive display that enables users to select sub-rankings and view undergraduate institution ranking within sub-rankings

16. The system of claim 15, the at least one processor further configured to order undergraduate institutions by counting the number of the members of each group that have respectively achieved the outcome of the at least some of the plurality of sub-rankings, counting the number of the members of each group, and dividing the number of members of each group that have respectively achieved the outcome of the at least some of the plurality of sub-rankings by the number of members of each group.

17. The system of claim 16, the at least one processor further configured to produce a composite ranking of the undergraduate institutions.

18. The system of claim 17, the at least one processor configured to produce the composite ranking by taking a weighted average of each undergraduate institution's ranking score in each of the at least some of the plurality of sub-rankings, and ranking the undergraduate institution according to the sum of the weighted averages for the undergraduate institution.

19. The system of claim 18 wherein each sub-ranking is weighted by the prevalence of the desirable outcome of the sub-ranking from the Career Guide to Industries produced by the U.S. Department of Labor, Bureau of Labor Statistics.

20. The system of claim 16 wherein the desirable outcomes include at least one outcome from the group of outcomes consisting of acceptance to business school, acceptance to law school, acceptance to medical school, acceptance to a Ph.D. program, working for a banking company, working for a consulting company, holding a position of executive leadership, working in the higher education industry, working for a technology company, working with a job function of writing or journalism, and starting a business.

21. The system of claim 20 wherein the at least one of the desirable outcomes is acceptance to a top business school, acceptance to top law school, acceptance to top medical school, working for a top banking company, working for a top consulting company, or working for a top technology company.

22. A method comprising:
using at least one data processor, creating a plurality of sub-rankings of desirable outcomes;
identifying members of a social network service who have listed a predetermined indicator in their social network service member profiles;
grouping the members by an institution with which they are associated in their member profile;
for at least some of the plurality of sub-rankings, ordering institutions by the proportion of members associated with the institution in their member profile who respectively achieved the outcome of the at least some of the plurality of sub-rankings; and
providing signals to render a display of the ordered institutions by sub-ranking, the display being an interactive display that enables users to select sub-rankings and view institution ranking within sub-rankings
